(19) United States
(12) Patent Application Publication
(10) Pub. No.: US 2011/0100066 A1
(43) Pub. Date: May 5, 2011

(54) DEVICE FOR JOINING AND TAPERING FIBERS AND OTHER OPTICAL COMPONENTS

(75) Inventors: Steffen Böhme, Jena (DE); Thomas Peschel, Jena (DE); Ramona Eberhardt, Bucha (DE); Andreas Tünnermann, Weimar (DE); Jens Limpert, Jena (DE)

(73) Assignee: Fraunhofer-Gesellschaft zur Forderung der Angewandten Forschung e.V

(21) Appl. No.: 12/993,680

(22) PCT Filed: May 19, 2009
(86) PCT No.: PCT/EP09/03800

§ 371 Date: Jan. 20, 2011

(30) Foreign Application Priority Data
May 19, 2008 (DE) 102008024136.9

(51) Int. Cl. G02B 6/255; C03B 37/14

(52) U.S. Cl. 65/501

(57) ABSTRACT

A device for joining and tapering optical components such as fibers includes a retaining device for holding optical components in a processing site, a laser radiation source for emitting a laser beam and beam forming elements for guiding the laser beam to the processing site. At least a first beam forming element is inserted into the beam path of the laser radiation source for producing a radiation having the form of an annulus and a second beam forming element is provided for specifying the angle of incidence of the radiation having the form of an annulus onto the optical components at the processing site.

### CROSS-REFERENCE TO RELATED APPLICATIONS

The present application is a national phase application of PCT application PCT/EP2009/003800 filed pursuant to 35 U.S.C. §371, which claims priority to DE 10 2008 024 136.9, filed May 19, 2008. Both applications are incorporated herein by reference in their entirety.

### TECHNICAL FIELD

The invention relates to a device for joining and tapering fibers and other cylindrical optical components.

### BACKGROUND

Various devices are known for joining fibers and other cylindrical or rotationally symmetrical optical components, such as by welding, splicing, fusion and tapering. In some of them, the energy input is effected essentially by heat radiation, produced by specially shaped heating wires, such as filaments or via electric arcs. In order to achieve the energy input to the optical fiber by heat radiation, the fiber must be positioned very closely against the heating wire or electric arc. The problem thereby exists that filament deposits or even gas residues may contaminate the optical fiber. Furthermore, the life span of a heating wire is not very long.

In order to achieve an improvement, an attempts have been made to use larger and higher-performance filaments also made of other materials. This is however inefficient because of the indirect heating. However, also new problems result with other materials, such as e.g. the requirement for gradual heating with the material graphite. Furthermore, different heating wire geometries must be used for different fiber diameters.

Therefore, splicing devices in which a direct energy input is undertaken by the absorption of the laser wavelength of a CO₂ laser have been conceived. A device is known from EP 0 505 044 A2 for splicing the ends of two optical fibers portions that includes means for contacting the ends and aligning the fiber portions along a common axis. Furthermore, means for welding the fiber portions are provided, which means have a laser source and means for directing a divergent conical beam towards a parabolic mirror, the axis of the parabolic mirror corresponding to that of the aligned optical fiber portions. In this device, the length of the parts to be processed is limited since one of the scanner mirrors is situated in the optical axis of the fiber.

### SUMMARY

In some embodiments, the invention is directed to producing a device for joining and tapering fibers and/or other cylindrical optical components, which device improves the known state of the art and has a relatively simple construction, the processing of different diameters and lengths of the workpieces to be processed being intended to be possible.

In some embodiments, and as a result of inserting at least a first beam-forming element for producing an annular radiation into the beam path of the laser beam emitted from the laser source and as a result of providing a further beam-forming element for specifying the angle of incidence of the annular radiation onto the fiber(s) and/or the cylindrical optical components at the processing position, a homogeneous conical energy input is made available in a simple manner with selectable angles of incidence, as a result of which a homogeneous heat conduction becomes possible after the absorption and hence a uniform, spatially very limited melting. Processing possibilities are joining, tapering, polishing, cleaning or the like.

In some embodiments, annular radiation is produced simply by using two reflex axicons or a double axicon as a first beam-forming element. The spacing of the parts of the double axicon or of the two reflex axicons prescribe the annular diameter.

In an embodiment, the spacing can therefore be adjusted in order to achieve different annular diameters. As a result, different workpiece sizes can be processed with only one device configuration, the workpiece geometries being able to have a diameter range of less than 100 μm up to greater than 1,500 μm. Optical components of any size, such as functional elements or plane-parallel plates, e.g. end caps, wedge plates etc., can be joined to fibers of any diameter by splicing. A continuous change in the diameters of the welding partners is very simple to accomplish without calibration. Furthermore, also other cylindrically-shaped elements, such as other optical components, can be processed. The restrictions are provided only by the mechanical receiving means of the components to be spliced and the available, readily reproducible laser power.

By providing means for variable adjustment of the angle of incidence at the processing site, for example by means of a stepped axicon or parabolic mirror in conjunction with the double axicon or the two reflex axicons, the angle of incidence can be advantageously adjusted variably for different processing processes (tapering, splicing).

In some embodiments, the angle of incidence of the laser may be chosen such that the processing site can be observed always perpendicular to the workpiece axis, e.g. fiber axis, for example by means of a CCD camera, as a result of which adjustment in two orthogonal planes of the workpiece or workpieces to be processed is permitted or facilitated.

Furthermore, in some embodiments, the angle of incidence is chosen such that a prescribed spacing between processing site and a planar mirror is provided. The provided spacing is defined such that the planar mirror is not influenced by the processing process, e.g. by smoke or gases, i.e. is not contaminated. In some embodiments, the spacing is greater or equal to 10 mm.

In some embodiments, the axicon or double axicon which is used can operate in reflection or transmission.

In some embodiments, the second beam-forming element for adjusting the angle of incidence is a further axicon that directs the annular radiation to the joining or tapering site. The use of a further double axicon in stepped form is advantageous, as a result of which the adjustment of the angle of incidence, in particular in the case of a double axicon as first beam-forming element, can be undertaken.

In some embodiments, and in order to project a laser beam unfocused towards the processing or joining or tapering site and to reduce the power density on the surface to be processed, the stepped axicon for adjusting the angle of incidence can be provided with an additional sphere, asphere or diffractive structure that produces a divergent/convergent reflected radiation. Of course, this can also be achieved by interposing a further optical element. Improved homogenization of the laser radiation leads in total to a homogeneous tapering or splicing result with simultaneously more relaxed tolerances, i.e. adjustment of the fibers relative to each other and to the laser ring. As a result, the process stability and reproducibility is improved in total.

Another embodiment of the second beam-forming element for specifying the angle of incidence is the use of a parabolic mirror. As a result, it becomes possible to change the radiation incidence from grazing to vertical. For the parabolic mirror, the above-mentioned applies with respect to changing the power density.

Yet another embodiment of the second beam-forming element is a focusing lens that is subsequently connected to the double axicon. Workpieces of different diameters can be processed by means of the laser ring which is deflected at the planar mirror and tapers conically.

In some embodiments, the planar mirror which can be used in conjunction with all embodiments, is slotted or divided and provided with a likewise divided hole boring in order to supply thus the workpieces or their mounting to be processed. This applies equally to the stepped axicon or the parabolic mirror configured as second beam-forming element.

In some embodiments, by using the planar mirror in front of the processing site, adjustment is simplified since functional separation between prepositioned focusing optical device (two reflex axicons, double axicons) and beam deflection is achieved by the planar mirror. Since the laser ring is intended to surround the workpiece homogeneously, a divided planar mirror with likewise divided hole boring offers, on the one hand, an uninterrupted laser ring. On the other hand, by opening the divided planar mirror with the hole boring, e.g. by means of a hinge, a very advantageous fitting of the workpiece can be effected. In particular long workpieces, such as e.g. optical fibers, can be of any length and need not be “threaded” through a hole boring for the processing.

In some embodiments, a telescope for adaptation of the laser beam diameter and possibly of the power density at the processing or joining or tapering position is disposed subsequent to the laser beam source.

In summary, it can be said that, with this universal, relatively compact device configuration according to the invention, the existing restrictions with respect to homogeneous energy input with simultaneously adapted process management, i.e. adaptation to the geometries or to that of the workpieces to be processed can be significantly extended.

An advantageous development for the mounting of the respective axicon resides in the fact that a planar plate made of a material which is highly transmittive for the laser radiation, e.g. zinc selenide with AR silvering, and a hole boring for fixing the axicon tip is used as retaining element for the axicon tip. As a result, the laser beam geometry (i.e. the ring) is not disrupted and the laser radiation is not blocked.

The device according to the invention can be used for workpieces with different diameters without renewed calibration. In addition to pure silica glass/quartz glass, doped silica and quartz glasses and also all other glasses which are absorbent in the wavelength range used, and also derivatives thereof, e.g. grin lenses produced for example by ion exchange and based on borosilicate glass, can be melted on insofar as the expansion coefficient of the joining partners allows this. Also for the tapering of symmetrical, shaped bodies, such as e.g. optical fibres, new possibilities arise with the CO₂ laser since substantially thicker glasses can be processed due to the symmetrical energy input. Hence, processing of other cylindrical materials which absorb laser radiation in this wavelength range is possible.

As a result of the fact that a highly transparent plate with a hole for receiving and precise fixing of the conical tip of the axicon is used for the mounting of one of the axicons of the double axicon or of the two reflex axicons, the laser radiation is not disturbed. In some embodiments, the highly transparent plate is made of zinc selenide.

### BRIEF DESCRIPTION OF THE FIGURES

Embodiments of the invention are represented in the drawing and explained in more detail in the subsequent description.

FIG. 1 is a schematic construction of a first embodiment of the device according to the invention with a double axicon as first beam-forming element and a stepped axicon as second beam-forming element.

FIG. 2 is a second embodiment with a double axicon as first beam-forming element and a parabolic mirror as second beam-forming element.

FIG. 3 is a third embodiment of the device according to the invention with a double axicon as first beam-forming element and a focusing lens as second beam-forming element.

### DETAILED DESCRIPTION

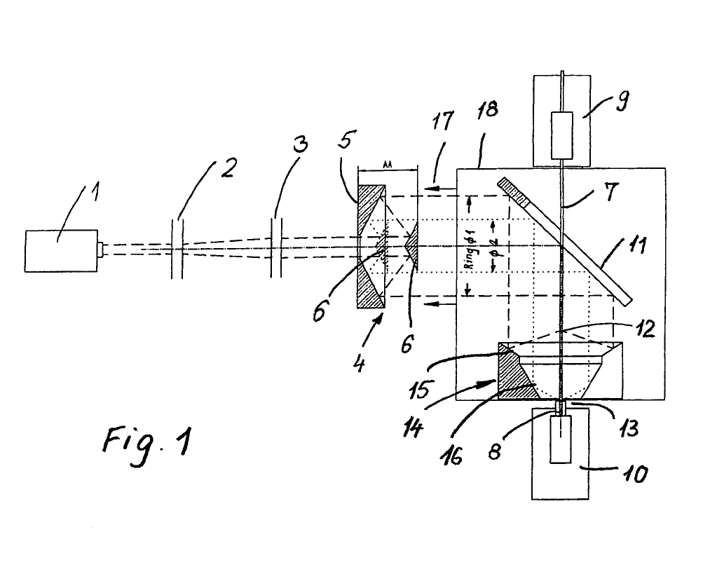

The device represented in FIG. 1 has a CO₂ laser 1 that projects a laser beam onto a telescope with a first lens 2 and a second lens 3, which telescope serves for adaptation of the laser beam diameter. Subsequently to the telescope 2, 3 a double axicon 4 is disposed that operates in reflection and includes a negative first axicon 5 of annular shape and a positive second axicon 6 of conical shape at a spacing AA, which have the same absolute angles for producing a constant annular diameter. The axicon 5 includes a passage for accommodating passage of the laser beam that comes from the telescope 2, 3 and impinges on the second axicon 6. The spacing AA between the two axicons 5, 6 can be adjusted continuously, with the spacing AA determining the annular diameter of the transmitted laser radiation. In FIG. 1, the second axicon 6 is shown in two different positions, as a result of which the beam path with the laser annular diameter Φ1, represented in broken lines, and the beam path with the laser annular diameter Φ2, in dotted lines, is produced. The radiation impinging on the second axicon 6 is reflected on the conical surfaces, impinges on the first axicon 5 and is likewise reflected there.

The workpiece parts 7, 8 to be joined as welding partners, which can be configured for example as optical fiber or other optical components including cylindrical optical components, are received respectively in a motor-driven axis with holder 9, 10 and aligned relative to each other. In the annular beam path, a slotted planar mirror 11 or one divided in two and able to be adjusted relative to each other, the halves of which can also be connected respectively by a hinge, is disposed, the first welding partner 7 engaging through the slot of the planar mirror 11. In the divided embodiment, the planar mirror 11 has a likewise divided hole boring for passage of the workpiece.

A stepped axicon 14 is provided for concentrating the annular radiation, which is deflected by 90° by the planar mirror 11 in the present embodiment, onto the welding site 12, 13, the laser radiation with the larger annular diameter being reflected on the conical surface of the first axicon 15 of the stepped axicon 14 and impinging on the welding site 12 or the joining site. The laser radiation with the smaller annular diameter 2 is directed towards the second axicon 16 of the stepped axicon 14 with a more acute conical angle and, as can be detected from the Figure, reflected towards the welding site or the joining site 13. The stepped axicon 14 can likewise have a slotted or divided configuration like the planar mirror.

In some embodiments, when using a slotted planar mirror and a slotted stepped axicon, this arrangement can be moved to the left in the drawing in order to enable fitting of the holders 9, 10 as indicated by the arrows 17 and the box 18. The arrangement is moved back again for processing with the laser. However, it also suffices if merely the divided planar mirror 11 with hole boring and possibly the divided stepped axicon 14 are opened and closed for fitting the retaining device. The hole in the planar mirror 11 defines the maximally adjustable angle of incidence, e.g. relative to the optical fibre axis.

As can be detected from this arrangement, by adjusting the spacing AA between the first and second axicon of the double axicon 4 and the inclination of the conical surfaces of the first and second axicon 15, 16 of the stepped axicon 14, the welding or joining site 12, 13 and the angle of incidence of the laser radiation onto the welding or joining site 12, 13 can be changed. An additional sphere, asphere or diffractive structure or a plurality thereof can be incorporated in the surfaces of the stepped axicon 14, as a result of which the power density of the reflected radiation at the welding or joining site 12, 13 is specifically influenced. However, a separate optical component can be provided for this purpose.

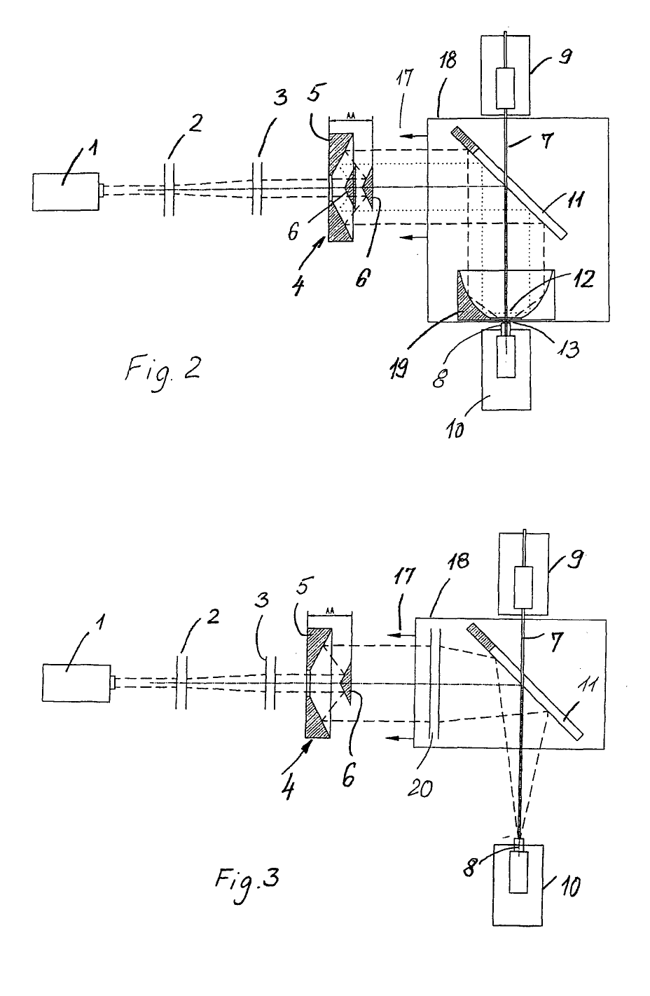

In FIG. 2, a second embodiment of the arrangement according to the invention is represented, which embodiment differs from the first arrangement by a parabolic mirror 19 which is likewise slotted or divided for passage of the workpiece, according to the embodiment, being used instead of the stepped axicon 14 in FIG. 1. The mode of operation is basically essentially the same as in FIG. 1.

In FIG. 3, the double axicon 4 to which a focusing lens 20 is subsequently connected is used in turn, the focused annular radiation impinging once again on the planar mirror 11 that directs the radiation towards the joining site.

In this embodiment, the spacing between the first axicon 5 and the second axicon 6 of the double axicon 4 may be firmly adjusted, the focusing lens 20 being assigned to this adjustment.

In the various embodiments, the telescope 2, 3 serves for adaptation of the laser beam diameter. The telescope 2, 3 also contributes to a certain degree to the adaptation of the power density at the welding or joining site.

No mounting is represented for the double axicon or the reflex axicon. In some embodiments, the respective axicon is mounted in such a manner that it causes no disturbances to the laser radiation. This can be achieved for example by using a transmittive plane-parallel plate, e.g. made of zinc selenide with an antireflection coating, which is provided with a hole for receiving the cone tip of the axicon and hence serves as holder. The conical tip is connected to the plate e.g. by attachment means or glueing.

1-17. (canceled)

18. A device for joining and tapering optical components, the device comprising:
a retaining device for retaining the optical components at a processing site;
a laser beam source for emitting a laser beam along a beam path; and
beam-forming elements for directing the laser beam towards the processing site; the beam-forming elements including a first beam-forming element for producing an annular radiation, the first beam-forming element disposed in the beam path and a second beam-forming element for specifying an angle of incidence of the annular radiation onto the optical components.

19. The device of claim 18, wherein the optical components comprise fibers.

20. The device of claim 18, wherein the first beam-forming element comprises two reflex axicons or a double axicon with parts at a spacing from each other, the spacing of the two reflex axicons or the two parts prescribing the annular diameter of the radiation.

21. The device of claim 18, further comprising means for variable adjustment of the angle of incidence.

22. The device of claim 20, wherein the spacing of the reflex axicons or the parts of the double axicon is adjustable in order to achieve different annular diameters of the radiation.

23. The device of claim 22, wherein the spacing is continuously adjustable.

24. The device of claim 21, wherein the second beam-forming element comprises another axicon or a parabolic mirror that directs the annular radiation towards the processing site.

25. The device of claim 24, wherein the axicon comprises a stepped axicon.

26. The device of claim 18, wherein the angle of incidence can be adjusted such that the processing site is visible perpendicular to an axis of the optical component.

27. The device of claim 18, further comprising a planar mirror disposed between the first and second beam-forming elements or between the second beam-forming element and the processing site, the planar mirror for deflecting the annular radiation.

28. The device of claim 27, wherein a spacing between the processing site and the planar mirror is greater than or equal to 10 mm.

29. The device of claim 18, wherein the second beam-forming element comprises a focusing lens.

30. The device of claim 25, wherein the means for variable adjustment of the angle of incidence include the stepped axicon or the parabolic mirror.

31. The device of claim 27, wherein the planar mirror is divided in two and includes at least one of a hole boring or a slot.

32. The device of claim 25, wherein the stepped axicon or the parabolic mirror are divided or slotted.

33. The device of claim 25, further comprising means for reducing or changing a power density of the radiation at the processing site provided in the beam path.

34. The device of claim 33, wherein the means for reducing or changing a power density are configured as a structure that is incorporated in the stepped axicon or the parabolic mirror in order to reduce the power density of the radiation.

35. The device of claim 18, further comprising a telescope for adaptation of the laser beam diameter and optionally the power density at the processing site, the telescope disposed subsequent to the laser beam source.

36. The device of claim 27, wherein at least one of the planar mirror, the stepped axicon or the parabolic mirror is movable and/or can be opened and closed in order to fit the retaining device.

37. The device of claim 20, wherein at least one axicon of the double axicon or of the two reflex axicons has, as holder, a plate which is highly transparent in the laser wavelength range and has a hole for mounting a conical tip.
